(19) United States
(12) Patent Application Publication
(10) Pub. No.: US 2008/0284732 A1
(43) Pub. Date: Nov. 20, 2008

(54) Computer mouse bearing personalized and replaceable graphical indicia

(76) Inventors: Rita Rovery, Forest Hills, NY (US); Karen Crowley, Jamesville, NY (US)

Correspondence Address: LAW OFFICES OF JOHN R. MUGNO, 350 BROADWAY - 10TH FLOOR, NEW YORK, NY, 10013, US

(21) Appl. No.: 11/804,475

(22) Filed: May 18, 2007

(51) Int. Cl. G06F 3/033

(52) U.S. Cl. 345/163

(57) ABSTRACT

A computer mouse is described comprising a bottom surface movable on a flat surface, an upper surface comprising a switch actuator portion, and a distending portion between the bottom surface and the upper surface. In the first embodiment of the present invention, a detachable and transparent hand rest portion is provided that can be affixed to the upper surface of the computer mouse. Graphical material can be placed beneath this detachable and transparent hand rest portion so that it is visible to the user. In a second embodiment of the present invention, a computer mouse comprises a bottom surface movable on a flat surface, an upper surface comprising a hand rest portion and a switch actuator portion, a distending portion between the bottom surface and the upper surface, and a detachable transparent cover overlaying said hand rest portion wherein said cover is sized to be selectively snapped on and off said computer mouse and incorporates sufficient space between the hand rest portion and said cover to permit placement of graphical material. In both preferred embodiments, the graphical material can be readily replaced at no additional costs.

### FIELD OF THE INVENTION

This invention is generally directed to a computer mouse utilized to operate and control a computer. More specifically, the present invention provides an operational computer mouse having a bottom surface movable on a flat surface (such as a mouse pad), an upper surface comprising a switch actuator portion, a distending portion between the bottom surface and the upper surface, and a transparent hand rest portion on the upper surface under which graphical indicia can selectively be placed and is visible. The graphical indicia can take the form of a photograph, a corporate logo, computer instructions, a hologram, or any other two-dimensional information. The graphical indicia is easily replaceable by the user.

### BACKGROUND OF THE INVENTION

A computer mouse is a well-known device used in conjunction with the operation of a personal computer. A computer mouse, in general, allows a user to change the position of a cursor on a screen or monitor to operate various functions of the computer without the need for typing commands. Generally, the computer mouse comprises a bottom surface movable on a flat surface (such as a mouse pad), an upper surface comprising a hand rest portion and a switch actuator portion, and a distending portion between the bottom and upper surfaces. A conventional computer mouse can be either wired or wireless. In the wired variation, a wire extends from the distending portion near the switch actuator portion of the computer mouse.

It has become commonly known to include visual indicia and/or protective covers on computer mice. For instance, Hiegel U.S. Pat. No. 6,404,539 provides an elastic, flexible material which overlays the upper surface and distending portion of a computer mouse. The purpose of the protective cover described in Hiegel U.S. Pat. No. 6,404,539 is to protect the upper surface of the mouse from potential contaminants, while permitting the bottom surface of the computer mouse to function properly. In this prior art patent, it is envisioned that visual indicia may be placed on the cover. However, since such visual indicia is printed directly on the disclosed protective cover, if the visual indicia ever needs to be changed, a new protective cover would be required.

Chinen U.S. Pat. No. 6,099,929 also discloses a protective cover for a computer mouse that can include advertising indicia. In this prior art device, an adhesive strip is provided on the upper surface of the computer mouse, whereby a flexible sheet is retained on the mouse with a free distal portion of the sheet extending over the actuator depressible keys of the mouse. The sheet can include written indicia. Once again, however, if new written indicia is desired, a new sheet will be required.

Held U.S. Pat. No. 6,099,934 discloses a cover for a computer mouse utilizing a sheath having a first portion extending around the side portion of the computer mouse. A flap connects to the sheath and includes a notch which aligns with portions of the switch-activated actuators on the computer mouse to permit access to the same. A fastener is also employed to anchor the sheath and connected flaps to the cord of the mouse. The flap provides a surface for presentation of indicia or for an attachment of three-dimensional objects.

Both Lee U.S. Pat. No. 6,697,051 and Ho U.S. Pat. No. 6,380,926 provide fanciful computer mice wherein the hand rest portion of the computer mouse includes a sealed transparent portion wherein three-dimensional objects can be placed. The sealed portions are permanent. Once opened, they cannot be repaired; a new mouse would be required.

One common shortcoming with each of the aforementioned prior art devices is that the visual indicia placed on the computer mouse cannot readily be changed. For instance, if an organization having thousands of employees had provided such prior art computer mice to all of its employees, and then changes its corporate name or logo, new computer mice or protective covers must be provided to each of these employees. Similarly, if an individual user obtains new family photographs, etc., a new protective cover incorporating this new graphical material must be created.

It is therefore a primary object of the present invention to provide a new and improved computer mouse incorporating interchangeable graphical materials.

It is yet another object of the present invention to provide a new and improved computer mouse that permits a user to adopt new graphical material with no additional costs.

Other objects and advantages of the present invention will become apparent from the specification and the drawings.

### SUMMARY OF THE INVENTION

Briefly stated and in accordance with the preferred embodiment of the present invention, a computer mouse is described comprising a bottom surface movable on a flat surface, an upper surface comprising a switch actuator portion, and a distending portion between the bottom surface and the upper surface. In the first embodiment of the present invention, a detachable and transparent hand rest portion is provided that can be affixed to the upper surface of the computer mouse. Graphical material can be placed beneath this detachable and transparent hand rest portion so that it is visible to the user. In a second embodiment of the present invention, a computer mouse comprises a bottom surface movable on a flat surface, an upper surface comprising a hand rest portion and a switch actuator portion, a distending portion between the bottom surface and the upper surface, and a detachable transparent cover overlaying said hand rest portion wherein said cover is sized to be selectively snapped on and off said computer mouse and incorporates sufficient space between the hand rest portion and said cover to permit placement of graphical material. In both preferred embodiments, the graphical material can be readily replaced at no or minimal additional cost.

### BRIEF DESCRIPTION OF THE DRAWINGS

While the specification concludes with claims particularly pointing out and distinctly claiming the subject matter regarded as the invention herein, it is believed that the present invention will be more readily understood upon consideration of the description, taken in conjunction with the accompanying drawings, wherein:

FIG. 1 is a schematic illustration of the placement of graphical material on a flat portion of an upper surface of a computer mouse in accordance with the first embodiment of the present invention;

FIG. 2 is a schematic illustration of the placement of a transparent and detachable hand rest portion on a computer mouse in accordance with the first embodiment of the present invention;

FIG. 3 is a side view of the completed computer mouse in accordance with the first embodiment of the present invention;

FIG. 4 is a top view of a completed computer mouse in conjunction with a first embodiment of the present invention;

FIG. 5 is a schematic illustration of a detachable transparent cover designed to overlay a hand rest portion of a computer mouse in accordance with the second embodiment of the present invention;

FIG. 6 is a schematic illustration of the detachable transparent cover of FIG. 5 being placed over a standard computer mouse in accordance with the second embodiment of the present invention;

FIG. 7 is a side view of a completed computer mouse in accordance with the second embodiment of the present invention; and

FIG. 8 is a top view of a completed computer mouse having a detachable transparent cover in accordance with the second embodiment of the present invention.

### DESCRIPTION OF THE PREFERRED EMBODIMENT

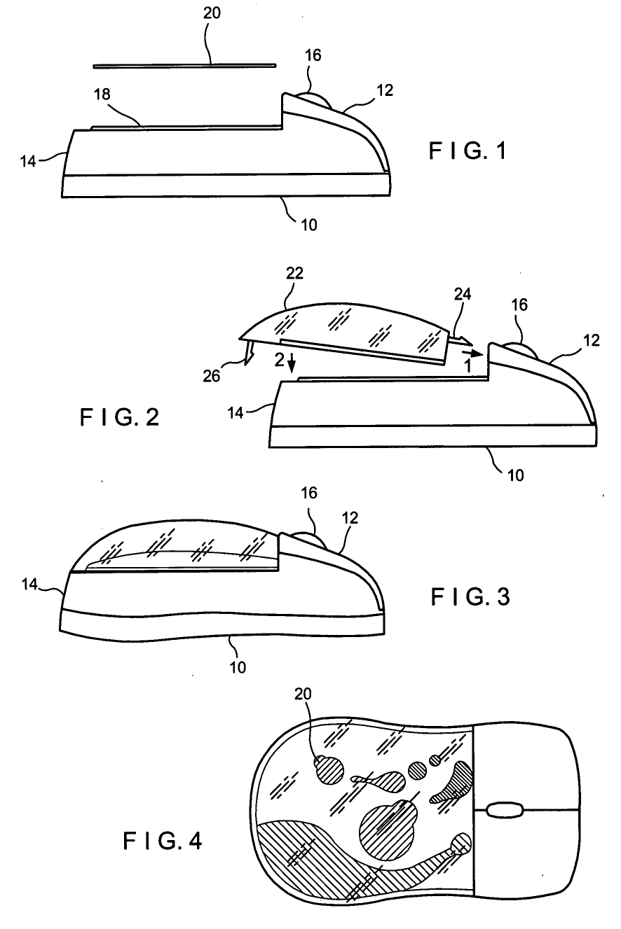

FIGS. 1-4 will be used to describe a first embodiment of the present invention. A computer mouse having a bottom surface 10, an upper surface 12, and a distending portion 14 is shown. Bottom surface 10 typically includes a roller ball or light (not shown) that is well known in the art. Bottom surface 10 is easily movable along a hard flat surface, such as a mouse pad. Upper surface 12 comprises a switch actuator portion 16, which is depicted in FIGS. 1-4 as a sliding roller. It is well known in the art that push buttons and other switch actuators can also be utilized for user interaction. Upper surface 12 also includes a graphical placement surface 18 upon which a graphical material 20 can be placed.

Referring specifically to FIG. 2, a detachable and transparent hand rest portion 22 is shown that includes a snap connector 24 and a snap connector 26. Hand rest portion 22 is first moved in the direction of directional arrow 1 to engage snap connector 24 to upper surface 12. Next, hand rest portion 22 is pushed downward (in the direction of directional arrow 2) to engage snap connector 26 to upper surface 12.

Once the apparatus is completely attached, the computer mouse will have the appearance as set forth in the side view of FIG. 3 and the top view of FIG. 4. The device is fully operational but includes graphical material 20 as seen in FIG. 4. While the graphical indicia shown in FIG. 4 is nothing more than a fanciful design, it should be noted that this graphical material can include advertising materials (such as a corporate logo), personal photographs, computer instructions, a listing of frequently visited websites, or any other imaginable two-dimensional images. If the user ever desires to replace the graphical material, transparent and detachable hand rest portion 22 can easily be removed and graphical material 20 can be readily replaced.

While, in connection with the description of FIGS. 1-4, snap connectors 24 and 26 have been utilized to connect hand rest portion 22 to upper surface 12, numerous other attachment means can be utilized. For instance, a commonly known hook and tile fastener could be utilized. Moreover, while graphical placement surface 18 has been shown as being substantially flat, it can also be comprised of a concave or convex surface.

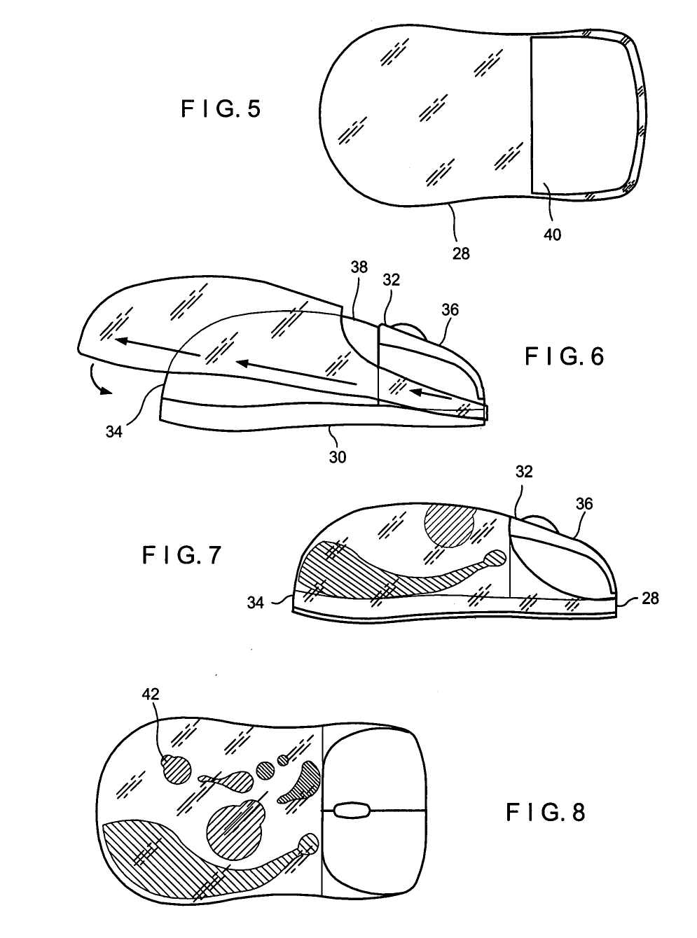

A second preferred embodiment of the present invention is described in conjunction with FIGS. 5-8. In FIG. 5, a slightly elastic and flexible transparent cover 28 is depicted. Transparent cover 28 will be utilized in conjunction with a standard shaped mouse to permit the graphical material to be both visible seen and easily replaced by a user. FIG. 6 depicts a computer mouse having a bottom surface 30, an upper surface 32, and a distending portion 34. Upper surface 32 comprises a switch actuator portion 36 and a hand rest portion 38. Transparent cover 28 is stretched over the apparatus as depicted in FIG. 6 such that actuator portion 36 and bottom surface 30 remain completely accessible and fully operational. Transparent cover 28, while fitting somewhat snugly over hand rest portion 38, will permit a graphical material 42 to be placed over hand rest portion 38. In the depiction of the second embodiment of the present invention, while cover 28 has been described as having a hollowed area 40 to permit functional access to switch actuator portion 36, it should also be understood that cover 28 can instead be designed to only envelop hand rest portion 38, while still permitting the placement of graphical material 42. As with the first embodiment of the present invention, a user can easily replace the graphical material that is visible without any additional expense or the replacement of any components. This flexibility allows for the personalization of the computer mouse.

It should be readily apparent from the foregoing description of the two preferred embodiments of the present invention that a computer mouse has been provided that allows for modifications to displayed visual indicia. However, many variations of the preferred embodiment are clearly envisioned. For instance, while the computer mice depicted in the subject drawings do not include a wire, it will be readily understood by those skilled in the art that a wire can be connected, typically to the distending portion of the computer mouse. Moreover, although a standard designed computer mouse has been shown, other variations are possible. Additionally, the use of the term “transparent” as utilized herein is not intended to cover only materials that are clear. Instead, any material through which images can be seen all also considered herein to be transparent. Thus, partially or fully tinted or polarized materials are deemed to be transparent as the term is used herein, including in the claims. It is also envisioned that computer software could be provided that will permit a user to design and print any desired graphical representation.

While there has been shown and described what is presently considered to be two preferred embodiments of this invention, it will be obvious that various changes and modifications may be made without departing from the broader aspects of this invention. It is, therefore, aimed in the appended claims to cover all such changes and modifications as fall within the true scope and spirit of the invention.

We claim:

1. A computer mouse comprising:
a bottom surface movable on a flat surface;
an upper surface comprising a hand rest portion and a switch actuator portion;
a distending portion between said bottom surface and said upper surface; and
a detachable transparent cover overlaying said hand rest portion wherein said cover is sized to be removable snapped on and off said mouse and has sufficient space between said hand rest portion and said cover to permit placement of interchangeable graphical material beneath said transparent cover.

2. The computer mouse of claim 1 wherein said detachable transparent cover is comprised of a slightly flexible material to permit to be detached and attached from said computer mouse.

3. The computer mouse of claim 1 wherein said detachable transparent cover comprises a snap connector.

4. The computer mouse of claim 1 wherein said detachable transparent cover extends along substantially the entire surface of said upper surface while incorporating a hollowed area over said switch actuator portion.

5. The computer mouse of claim 1 wherein said detachable transparent cover extends only substantially over said hand rest portion while leaving said switch actuator portion uncovered.

6. The computer mouse of claim 1 wherein said graphical material comprises a photograph.

7. The computer mouse of claim 1 wherein said graphical material comprises advertising information.

8. The computer mouse of claim 1 wherein said graphical material comprises instructional information.

9. A computer mouse comprising:
a bottom surface movable on a flat surface;
an upper surface comprising a switch actuator portion and a graphics placement portion on which graphical material can be placed;
a distending portion between said bottom surface and said upper surface; and
a detachable transparent hand rest portion over said flat portion of said upper surface.

10. The computer mouse of claim 9 wherein said detachable transparent cover comprises a snap connector.

11. The computer mouse of claim 9 wherein said graphical material comprises a photograph.

12. The computer mouse of claim 9 wherein said graphical material comprises advertising information.

13. The computer mouse of claim 9 wherein said graphical material comprises instructional information.

14. The computer mouse of claim 9 wherein said graphics placement surface is substantially flat.

15. The computer mouse of claim 9 wherein said graphic placement surface is curved.
